(19) United States
(12) Patent Application Publication
(10) Pub. No.: US 2015/0124995 A1
(43) Pub. Date: May 7, 2015

(54) PUBLIC ADDRESS SYSTEM WITH WIRELESS AUDIO TRANSMISSION

(71) Applicant: David Walter Defnet, Montgomery, TX (US)

(72) Inventor: David Walter Defnet, Montgomery, TX (US)

(21) Appl. No.: 14/517,461

(22) Filed: Oct. 17, 2014

Related U.S. Application Data
(60) Provisional application No. 61/899,578, filed on Nov. 4, 2013.

(51) Int. Cl. H04R 27/00

(52) U.S. Cl. CPC H04R 27/00
USPC 381/82

(57) ABSTRACT

A public address (PA) system that includes wireless audio transmission is disclosed. The system receives an analog audio input from a sound board or other output device. The audio input is converted to an encoded audio stream and broadcast using a wireless communication protocol. A mobile device can connect to the system, authorize a user, and decode the broadcast audio stream, which allows the user to enjoy the performance in real time.

### CROSS-REFERENCE TO RELATED APPLICATIONS

This application claims benefit under 35 U.S.C. §119(e) of U.S. Provisional Application having Ser. No. 61899578 filed Nov. 4, 2013, which is hereby incorporated by reference herein in its entirety.

### BACKGROUND

The embodiments herein relate generally to public address systems and more particularly to a public address system with a wireless audio transmission.

Currently, music concerts rely on large public address (PA) systems to produce audio for a crowd of individuals at the concert. However, there are several problems associated with current PA systems. They may be loud and produce a lot of noise pollution. The sound they create diminishes in volume as the listener moves away from the speakers. In order to compensate for the volume levels audible toward the rear of the venue, speakers positioned toward the front output higher volume sometime to the discomfort of audience members near the stage. However increasing volume may also increase the noise factor in the signal to noise ratio.

The sound quality of current PA systems may also be greatly affected by environmental factors, for example the wind. Audio technicians may labor to adjust the sound output for clarity in order to compensate for the combination of increased volume (and noise) and the environment which may distort the sound. Some approaches to adjusting sound through PA systems include, for example filtering out certain frequencies in the output. However filtering can sometimes lose desirable high frequencies (“highs”) which may be a prominent aspect of some performances. In addition, conventional PA systems may require a great deal of permits to use when outdoors because surrounding neighbors may find the volume undesirable.

With outdoor venues, people who do want to hear a performance may gather outside the venue and listen without paying, which decreases revenues for both the venue and the performer. As may be seen, there is a need for system that provides improved sound clarity to audience members of a venue.

### SUMMARY

According to one aspect of the present invention, a wireless public address (PA) system is disclosed for providing wireless access to a live performance while restricting access to only those audience members who have purchased access. The system comprises a wireless PA module configured to: receive an audio input from audio equipment providing an audio signal of the live performance, encode the audio signal of the live performance into an audio stream created from the audio input, and broadcast the audio stream via a wireless PA transmitter; and a mobile device configured to receive and decode the broadcast audio stream from the wireless PA transmitter.

According to another aspect of the present invention, a wireless public address (PA) module for providing restricted access to a live performance within a venue is disclosed. The PA module comprises an audio input configured to receive an audio input signal from audio equipment providing an audio signal of the live performance, a software module configured to, via a processor, encode the audio signal of the live performance into an audio stream created from the audio input, the audio stream including software code for restricting access to the audio stream to a mobile device permitted to receive the live performance, and a wireless PA transmitter configured to broadcast the encoded audio stream to the mobile device.

According to another aspect of the present invention, a computer program product for providing wireless access to a live performance within a venue while restricting access to only those audience members who have purchased access is disclosed. The computer program product comprises a non-transitory computer readable storage medium having computer readable program code. The computer readable program code is configured to: encode an analog audio signal of the live performance into an audio stream created from an audio input of audio equipment providing the audio signal of the live performance; encode restricted access to the audio stream to a mobile device permitted to receive the live performance; and broadcast the audio stream via a wireless PA transmitter to the mobile device permitted to receive the live performance.

### BRIEF DESCRIPTION OF THE FIGURES

The detailed description of some embodiments of the present invention is made below with reference to the accompanying figures, wherein like numerals represent corresponding parts of the figures.

FIG. 1 is a schematic view of a wireless PA system, according to an embodiment of the present invention.

FIG. 2 is a block diagram of a wireless PA module, according to an embodiment of the present invention.

FIG. 3 is a flowchart of a method of providing wireless access to a live performance, according to an embodiment of the present invention.

### DETAILED DESCRIPTION OF CERTAIN EMBODIMENTS

The embodiments herein relate generally to a public address system that wirelessly transmits audio from the performer's equipment to a mobile device so that an individual can listen to a live performance through headphones connected to the mobile device. Some embodiments may take the form of a software application that coordinates the transmission/reception of the audio signal of the live performance from the performer's equipment to the listener's mobile device.

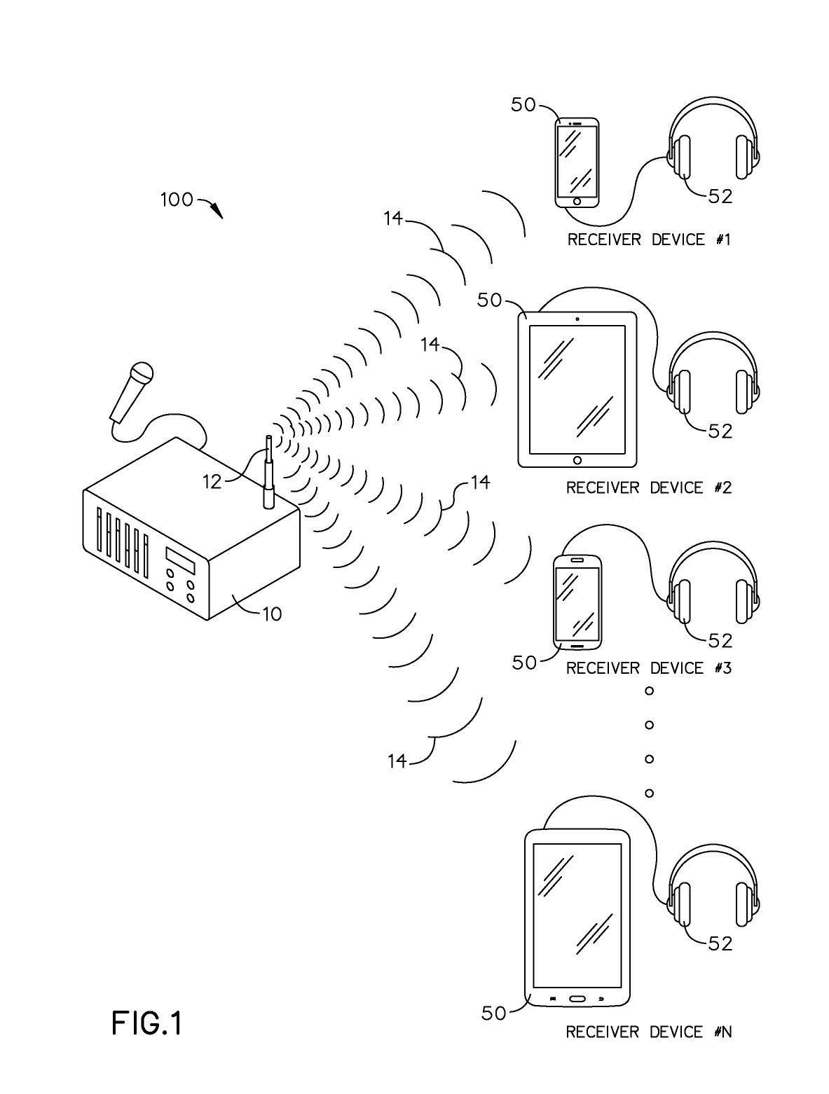

By way of example, and referring to FIG. 1, an embodiment of a PA system 100 is shown. The PA system 100 includes a wireless PA module 10 which includes a wireless PA transmitter 12 configured to broadcast an audio stream 14 wirelessly to one or more mobile devices 50. The mobile devices 50 may be coupled to headphones 52 so that individual audience members may hear the audio stream broadcast within the limits of the venue in a clean and undistorted fashion. The mobile devices 50 may be for example, mobile phones or tablet devices enabled for wireless connectivity. The mobile devices 50 may be physically within the limits of a venue or the audio stream is configured to be broadcast within physical limits of the venue so that individuals outside the venue cannot receive the transmission (for example, by configuring the signal strength of the broadcast to within a threshold level at a predetermined distance). The mobile device 50 may be configured to receive and decode the broadcast audio stream 14 from the wireless PA transmitter 12.

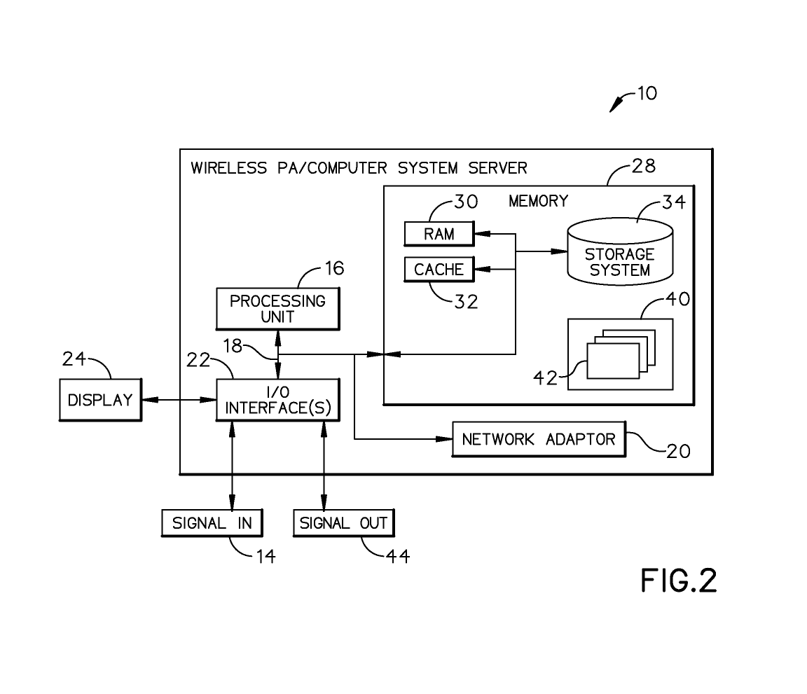

Referring now to FIG. 2, a schematic of an example of a wireless PA module 10. The wireless PA module 10 may in some embodiments function as a computer system/server 10 and in the form of a general-purpose computing device. The components of the wireless PA module 10 may include, but are not limited to, one or more processors or processing units 16, a system memory 28, and a bus 18 that couples various system components including the system memory 28 to the processor 16. The wireless PA module 10 may be configured to store software code that coordinates the functions of receiving audio input, converting the audio input into a digital audio stream, embedding security restrictions to allow only permitted members of the audience to receive the audio stream, and synchronize broadcast of the audio stream with a delayed broadcast of an analog audio signal of the live performance.

The wireless PA module 10 may typically include a variety of computer system readable media. Such media could be chosen from any available media that is accessible by the computer system/server 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device typically called a “hard drive” (not shown). The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. The program modules 42 generally carry out the functions and/or methodologies of embodiments of the invention as described herein. In the context of this disclosure, a computer readable storage medium may be any tangible or non-transitory medium that can contain, or store a program (for example, the program product 40) for use by or in connection with an instruction execution system, apparatus, or device.

The wireless PA module 10 may include an audio signal input jack 14 that enables the wireless PA module 10 to receive an analog audio signal of the live performance. The audio signal may be encoded into an audio stream and communicated with one or more other computing devices (for example, mobile devices 50) a signal out jack 44. Such communication can occur via Input/Output (I/O) interfaces 22. Alternatively, the wireless PA module 10 can communicate with one or more networks such as a local area network (LAN), a general wide area network (WAN), and/or a public network (e.g., the Internet) via a network adapter 20. As depicted, the network adapter 20 may communicate with the other components of the wireless PA module 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor 16 of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. For example, the audio stream 14 may be encoded with restrictions that permit authorized audience members within the venue with access to the audio stream via their mobile device 50. Likewise, the mobile device(s) 50 may download software embodiments of the subject technology to enable receipt of the audio stream.

The wireless PA module 10 may receive audio input from musical instruments, microphones, and other audio equipment connected to a sound board (not shown), as is well known in the art. In some embodiments, the sound board (not shown) may broadcast a conventional analog version of the live performance within the venue. The wireless PA module 10 may be connected to the sound board (not shown) coordinating a delayed broadcast of the analog audio signal to synchronize the broadcast of the audio stream with the delayed broadcast of the analog audio signal. The wireless PA transmitter 12 may be configured to broadcast the audio output of a concert or live performance so that it may only be received by an authorized app 12. For example, the wireless PA module 10 may support a wireless communication protocol, such as Wi-Fi and may function as a Wi-Fi access point or the like. The wireless PA module 10 may broadcast an encoded or encrypted audio stream. A mobile device 50 may connect to the Wi-Fi access point created by the wireless PA module 10. After connecting, the user may be prompted to install software embodiments of the subject technology if it is not already installed on the mobile device 50.

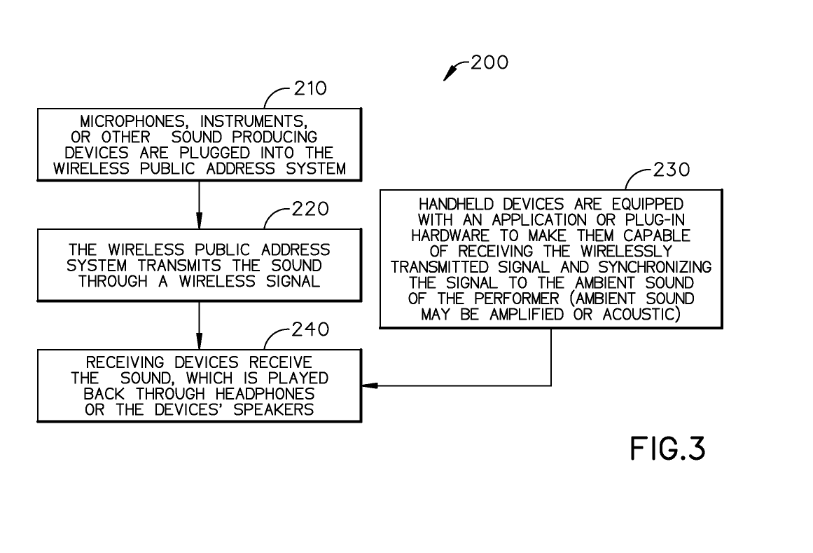

Referring now to FIG. 3, a method 200 of providing wireless access to a live performance while restricting access to only those audience members who have purchased access is shown according to an embodiment of the subject technology. In block 210 microphones, musical instruments, or other sound producing equipment are plugged in to a wireless PA module (for example, the wireless PA module 10). In block 220, the wireless PA module may encode an audio signal produced by the microphones, musical instruments, or other sound producing equipment into a digital audio stream and transmits the audio stream via a wireless signal. In block 230, mobile device equipped with software that can decode the audio stream, receive the wireless audio stream. In some embodiments, the wireless audio stream may be synchronized with the ambient sound of the live performance. In block 240, the mobile device receive the audio stream which may be heard through headphones or speakers of the mobile device.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A wireless public address (PA) system for providing wireless access to a live performance while restricting access to only those audience members who have purchased access, the system comprising:
a wireless PA module configured to:
receive an audio input from audio equipment providing an audio signal of the live performance,
encode the audio signal of the live performance into an audio stream created from the audio input, and
broadcast the audio stream via a wireless PA transmitter; and
a mobile device configured to receive and decode the broadcast audio stream from the wireless PA transmitter.

2. The wireless PA system of claim 1, further comprising headphones coupled to the mobile device.

3. The wireless PA system of claim 1, wherein the mobile device is configured to receive and decode the broadcast audio stream in response to the mobile device verifying that a user has permission to access the broadcast audio stream.

4. A wireless public address (PA) module for providing restricted access to a live performance within a venue, the PA module, comprising:
an audio input configured to receive an audio input signal from audio equipment providing an audio signal of the live performance,
a software module configured to, via a processor, encode the audio signal of the live performance into an audio stream created from the audio input, the audio stream including software code for restricting access to the audio stream to
a mobile device permitted to receive the live performance, and a wireless PA transmitter configured to broadcast the encoded audio stream to the mobile device.

5. The wireless PA module of claim 4, wherein the broadcast of the encoded audio stream to the mobile device is synchronized with an analog broadcast of the audio signal of the live performance from speakers.

6. The wireless PA module of claim 4, wherein the broadcast of the encoded audio stream is output to headphones of the mobile device in synchronization with an analog broadcast of the audio signal of the live performance from speakers connected to the audio equipment.

7. A computer program product for providing wireless access to a live performance within a venue while restricting access to only those audience members who have purchased access, the computer program product comprising a non-transitory computer readable storage medium having computer readable program code embodied therewith, the computer readable program code being configured to:
encode an analog audio signal of the live performance into an audio stream created from an audio input of audio equipment providing the audio signal of the live performance;
encode restricted access to the audio stream to a mobile device permitted to receive the live performance; and
broadcast the audio stream via a wireless PA transmitter to the mobile device permitted to receive the live performance.

8. The computer program product of claim 7, wherein the mobile device is physically located within the venue of the live performance.

9. The computer program product of claim 7, wherein the audio stream is configured to be broadcast within physical limits of the venue.

10. The computer program product of claim 7, further comprising computer readable program code being configured to:
delay broadcast of the analog audio signal;
synchronize the broadcast of the audio stream with the delayed broadcast of the analog audio signal.
